(19) United States
(12) Patent Application Publication
(10) Pub. No.: US 2022/0066200 A1
(43) Pub. Date: Mar. 3, 2022

(54) LASER SCANNING UNIT, IMAGE FORMING APPARATUS, LASER SCANNING METHOD, AND NON-TRANSITORY STORAGE MEDIUM

(71) Applicant: KYOCERA Document Solutions Inc., Osaka (JP)

(72) Inventor: Hideji Mizutani, Osaka (JP)

(21) Appl. No.: 17/411,371

(22) Filed: Aug. 25, 2021

(30) Foreign Application Priority Data
Aug. 28, 2020 (JP) 2020-144335

(51) Int. Cl. G02B 26/10; G03G 15/043

(52) U.S. Cl. CPC G02B 26/10; G03G 15/043

(57) ABSTRACT

A laser scanning unit includes a light source portion, a scanning portion, a first correction portion, and a second correction portion. The light source portion outputs a light beam. The scanning portion scans the light beam to form an electrostatic latent image in an image forming portion. The first correction portion applies an external mechanical force to an optical element located in a path of the light beam to correct inclination of a scan line of the light beam. The second correction portion controls the light source portion to correct distortion of the scan line of the light beam.

### INCORPORATION BY REFERENCE

This application is based upon and claims the benefit of priority from the corresponding Japanese Patent Application No. 2020-144335 filed on Aug. 28, 2020, the entire contents of which are incorporated herein by reference.

The present disclosure relates to a laser scanning unit, an image forming apparatus, a laser scanning method, and a non-transitory storage medium.

### BACKGROUND

As a related art, there is known an electrophotographic image forming apparatus of a tandem type that includes a plurality of image forming units and that transfers images of different colors in sequence onto a recording material held on a conveyor belt. A laser scanning unit (deflection scanning device) of the image forming apparatus according to the related art can electrically correct inclination of scan lines relative to the main scanning direction and distortion, such as curves, of the scan lines. That is, the related art prevents misregistration of a plurality of images after transfer by detecting the inclination, distortion, and the like and by emitting light beams (light rays) by amounts and at timings that enable correction of the detected inclination, distortion, and the like.

### SUMMARY

A laser scanning unit according to an aspect of the present disclosure includes a light source portion, a scanning portion, a first correction portion, and a second correction portion. The light source portion outputs a light beam. The scanning portion scans the light beam to form an electrostatic latent image in an image forming portion. The first correction portion applies an external mechanical force to an optical element located in a path of the light beam to correct inclination of a scan line of the light beam. The second correction portion controls the light source portion to correct distortion of the scan line of the light beam.

An image forming apparatus according to another aspect of the present disclosure includes the laser scanning unit and an image-carrying member on which the electrostatic latent image is formed by the light beam output from the laser scanning unit.

A laser scanning method according to yet another aspect of the present disclosure includes outputting a light beam from a light source portion, scanning the light beam to form an electrostatic latent image in an image forming portion, applying an external mechanical force to an optical element located in a path of the light beam to correct inclination of a scan line of the light beam, and controlling the light source portion to correct distortion of the scan line of the light beam.

A non-transitory storage medium according to yet another aspect of the present disclosure is a non-transitory computer-readable storage medium storing a program therein, wherein when executed by at least one processor, the program causes the processor to output a light beam from a light source portion, scan the light beam to form an electrostatic latent image in an image forming portion, apply an external mechanical force to an optical element located in a path of the light beam to correct inclination of a scan line of the light beam, and control the light source portion to correct distortion of the scan line of the light beam.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram of an image forming apparatus according to Embodiment 1.

FIG. 2 is a schematic diagram of an image forming portion in the image forming apparatus according to Embodiment 1.

FIG. 3 is a schematic diagram of a laser scanning unit in the image forming apparatus according to Embodiment 1.

FIG. 4 is a schematic diagram of the image forming portion in the image forming apparatus according to Embodiment 1 viewed from the bottom.

FIG. 5 is a schematic block diagram of the image forming apparatus according to Embodiment 1.

FIG. 6 is a schematic diagram of and around a first correction portion of the laser scanning unit according to Embodiment 1.

FIG. 7 is a flowchart showing an example of a laser scanning method according to Embodiment 1.

FIG. 8 is a graph showing the significance of the laser scanning unit according to Embodiment 1.

FIG. 9 is a graph showing the significance of the laser scanning unit according to Embodiment 1.

FIG. 10 is a graph showing the significance of the laser scanning unit according to Embodiment 1.

FIG. 11 is a schematic diagram of and around a third correction portion of an image forming apparatus according to Embodiment 2.

FIG. 12 is a schematic block diagram of an image forming apparatus according to Embodiment 3.

### DETAILED DESCRIPTION

The following describes embodiments of the present disclosure with reference to the accompanying drawings. It should be noted that the following embodiments are examples of specific embodiments of the present disclosure and should not limit the technical scope of the present disclosure.

### Embodiment 1

### Overall Configuration of Image Forming Apparatus

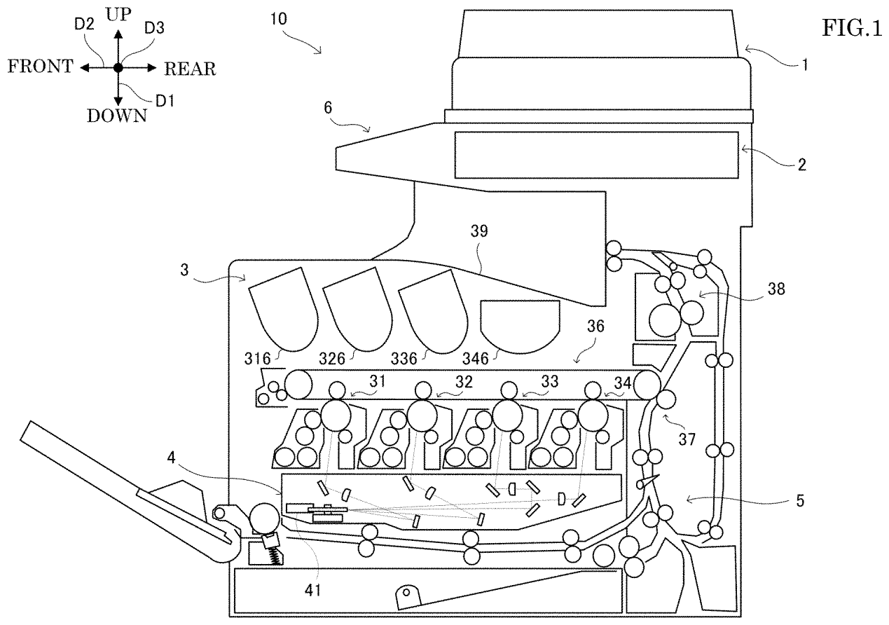

First, the overall configuration of an image forming apparatus 10 according to the present embodiment will be described with reference to FIG. 1.

For purposes of illustration, the vertical direction in a state where the image forming apparatus 10 is installed and ready for use (as shown in FIG. 1) is defined as an up-down direction D1. In addition, a front-rear direction D2 is defined provided that the left face, on the page, of the image forming apparatus 10 shown in FIG. 1 serves as the front (front face). In addition, a left-right direction D3 is defined relative to the front of the image forming apparatus 10 in the installed state.

As an example, the image forming apparatus 10 according to the present embodiment is a multifunction peripheral with multiple functions such as a scan function of reading image data from document sheets, a print function of forming images based on image data, a facsimile function, and a copy function. The image forming apparatus 10 may be any apparatus having the image forming function, including a printer, a facsimile apparatus, and a copier.

As shown in FIG. 1, the image forming apparatus 10 includes an automatic document feeder 1, an image reading portion 2, an image forming portion 3, a laser scanning unit 4, a sheet feed portion 5, and an operation display portion 6. In other words, the laser scanning unit 4 according to the present embodiment constitutes the image forming apparatus 10 together with the image forming portion 3 and the like. Hereinafter, the automatic document feeder 1 is referred to as “ADF 1” by its acronym.

The ADF 1 feeds a document sheet with an image to be read by the image reading portion 2. The ADF 1 includes a document sheet set portion, a plurality of conveying rollers, a document sheet holder, and a sheet discharge portion.

The image reading portion 2 reads the image from the document sheet and outputs image data corresponding to the read image. The image reading portion 2 includes a document sheet table, a light source, a plurality of mirrors, an optical lens, and a CCD (Charge Coupled Device).

The image forming portion 3 forms a color or monochrome image on a sheet by an electrophotographic method to implement the print function. The image forming portion 3 forms the image on the sheet based on the image data output from the image reading portion 2. In addition, the image forming portion 3 forms the image on the sheet based on image data input by an information processing apparatus, such as a personal computer, outside the image forming apparatus 10.

The sheet feed portion 5 supplies the sheet to the image forming portion 3. The sheet feed portion 5 includes a sheet feed cassette, a manual feed tray, a sheet conveyance path, and a plurality of conveying rollers. The image forming portion 3 forms the image on the sheet supplied by the sheet feed portion 5.

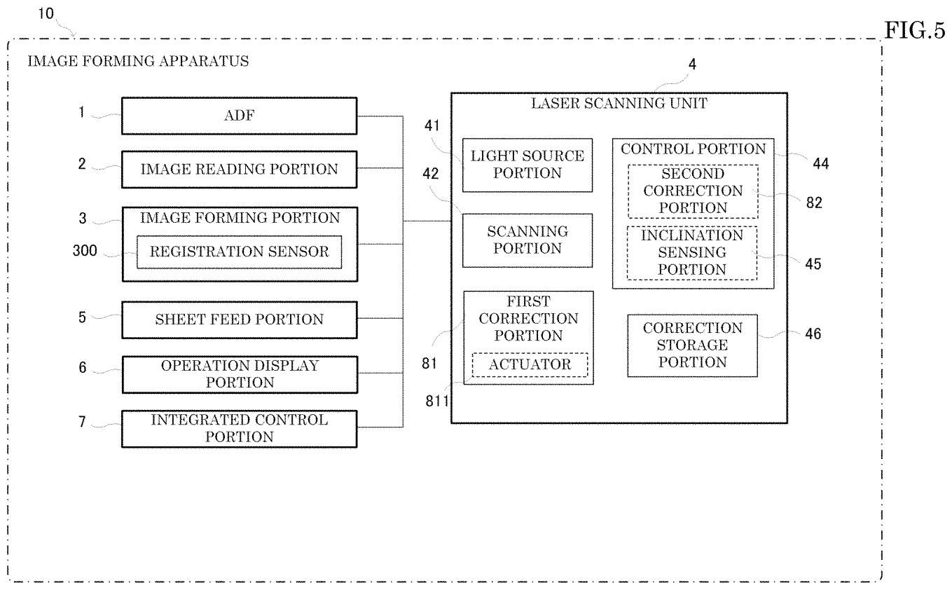

The operation display portion 6 is a user interface in the image forming apparatus 10. The operation display portion 6 includes a display portion and an operation portion. The display portion includes a liquid crystal display and displays various information according to control instructions from an integrated control portion 7 (see FIG. 5). The operation portion includes a switch and a touch panel for inputting the various information to the integrated control portion 7 according to user operations.

The image forming apparatus 10 further includes the integrated control portion 7, a storage portion, and a communication portion. The integrated control portion 7 provides integrated control of the image forming apparatus 10. The integrated control portion 7 is mainly composed of a computer system including one or more processors and one or more memories. In the image forming apparatus 10, the one or more processors execute programs to implement the function of the integrated control portion 7. The programs may be stored in the memories in advance, provided through telecommunication lines such as the Internet, or stored and provided in a non-transitory computer-readable storage medium such as a memory card or an optical disk. The storage portion includes one or more nonvolatile memories and stores in advance information including control programs to cause the integrated control portion 7 to perform various processes. The communication portion is an interface that performs data communication between the image forming apparatus 10 and, for example, an external apparatus connected via a communication network such as the Internet and a LAN (Local Area Network).

### [2] Configuration of Image Forming Portion

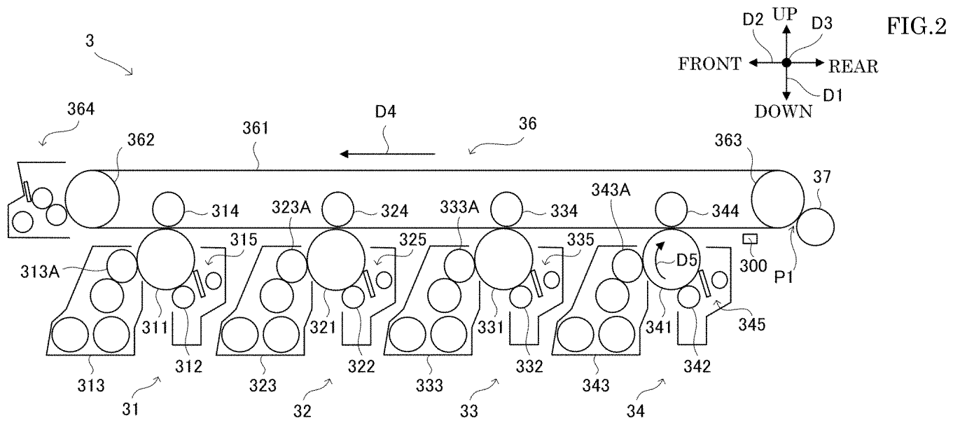

Next, the configuration of the image forming portion 3 will be described in more detail with reference to FIGS. 1 and 2.

As shown in FIG. 1, the image forming portion 3 includes four image forming units 31 to 34, an intermediate transfer device 36, a secondary transfer roller 37, a fixing device 38, and a sheet discharge tray 39.

The image forming unit 31 forms a toner image of yellow (Y). As shown in FIG. 2, the image forming unit 31 includes a photoconductor drum 311, a charging roller 312, a developing device 313 including a developing roller 313A, a primary transfer roller 314, and a drum cleaning member 315. The image forming unit 31 further includes a toner container 316 (see FIG. 1).

The image forming unit 32 forms a toner image of cyan (C). As shown in FIG. 2, the image forming unit 32 includes a photoconductor drum 321, a charging roller 322, a developing device 323 including a developing roller 323A, a primary transfer roller 324, and a drum cleaning member 325. The image forming unit 32 further includes a toner container 326 (see FIG. 1).

The image forming unit 33 forms a toner image of magenta (M). As shown in FIG. 2, the image forming unit 33 includes a photoconductor drum 331, a charging roller 332, a developing device 333 including a developing roller 333A, a primary transfer roller 334, and a drum cleaning member 335. The image forming unit 33 further includes a toner container 336 (see FIG. 1).

The image forming unit 34 forms a toner image of black (Bk). As shown in FIG. 2, the image forming unit 34 includes a photoconductor drum 341, a charging roller 342, a developing device 343 including a developing roller 343A, a primary transfer roller 344, and a drum cleaning member 345. The image forming unit 34 further includes a toner container 346 (see FIG. 1).

As described above, the plurality (herein four) of image forming units 31 to 34 respectively correspond to the four colors of yellow (Y), cyan (C), magenta (M), and black (Bk), and basically share a common structure. That is, the image forming apparatus 10 according to the present embodiment is an apparatus of a tandem type including a plurality of photoconductors (photoconductor drums) corresponding one-to-one with a plurality of colors. Accordingly, unless otherwise noted, the configurations of the image forming units 31 to 33 are identical to the configuration of the image forming unit 34 described below.

An electrostatic latent image is formed on the photoconductor drum 341. The photoconductor drum 341, the charging roller 342, and the drum cleaning member 345 are stored in a unit housing. The photoconductor drum 341 is supported by the unit housing to be rotatable around a rotational axis extending in the left-right direction D3. The photoconductor drum 341 is subjected to a driving force supplied by, for example, a motor and rotates in a rotation direction D5 shown in FIG. 2.

The charging roller 342 positively charges the surface (outer peripheral surface) of the photoconductor drum 341. Specifically, the charging roller 342 is electrically connected to a power circuit and charges the surface of the photoconductor drum 341 when subjected to high voltage (high-tension voltage) applied by the power circuit. It is noted that the charging roller 342 may charge the surface of the photoconductor drum 341 negatively instead of charging the surface positively.

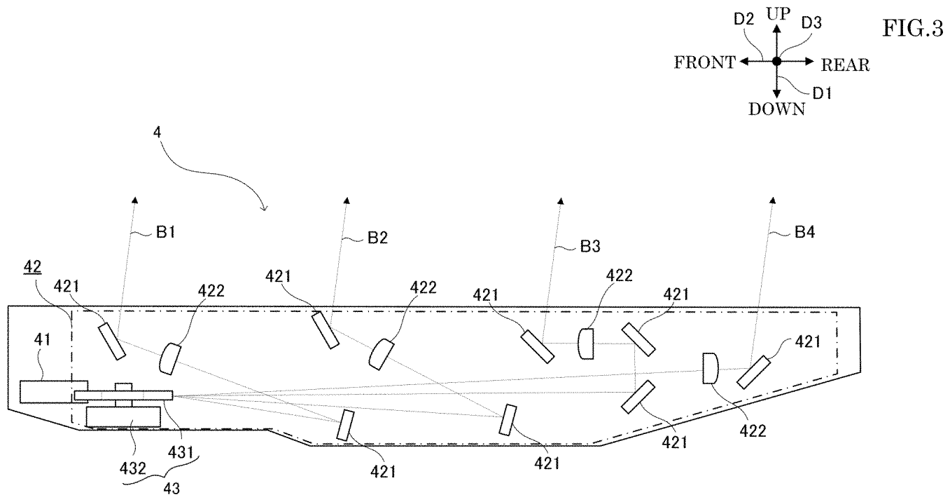

The surface of the photoconductor drum 341 charged by the charging roller 342 is exposed to a light beam B4 (see FIG. 3) based on the image data emitted by the laser scanning unit 4. This forms an electrostatic latent image on the surface of the photoconductor drum 341. That is, in the present embodiment, the photoconductor drum 341 is an example of an “image-carrying member” on which the electrostatic latent image is formed by the light beam B4 output from the laser scanning unit 4.

The developing device 343 develops the electrostatic latent image formed on the surface of the photoconductor drum 341. For example, the developing device 343 includes a case, a pair of stirring members, a magnet roller, and the developing roller 343A. The pair of stirring members, the magnet roller, and the developing roller 343A are supported by the case to be rotatable around respective rotational axes extending in the left-right direction D3. In addition, the case stores the toner of black (Bk) and carrier. The pair of stirring members stir the toner and the carrier stored in the case so that the toner is charged. In the present embodiment, the toner is charged positively. It is noted that the polarity of the toner is not limited to positive and may be negative. The magnet roller draws up the toner and the carrier stirred by the pair of stirring members and supplies only the toner to the surface (outer peripheral surface) of the developing roller 343A.

The developing roller 343A develops the electrostatic latent image formed on the photoconductor drum 341 using the charged toner. Specifically, a high-voltage developing bias is applied between the developing roller 343A and the photoconductor drum 341 by the power circuit such that a development field is created. The development field causes the toner with electric charges to move from the developing roller 343A to the photoconductor drum 341. This forms a toner image on the surface of the photoconductor drum 341.

The primary transfer roller 344 transfers the toner image formed on the surface of the photoconductor drum 341 by the developing device 343 to the outer peripheral surface of an intermediate transfer belt 361 (see FIG. 2). Specifically, a high-voltage transfer bias is applied between the photoconductor drum 341 and the primary transfer roller 344 by the power circuit such that a transfer field is created. The transfer field causes the toner with electric charges to move from the photoconductor drum 341 to the intermediate transfer belt 361. This forms (transfers) a toner image on the outer peripheral surface of the intermediate transfer belt 361.

The drum cleaning member 345 cleans the surface of the photoconductor drum 341 after the toner image is transferred by the primary transfer roller 344. For example, the drum cleaning member 345 includes a blade-like cleaning member and a conveyance member. The cleaning member comes into contact with the surface of the photoconductor drum 341 to remove the toner adhering to the surface. The conveyance member conveys the toner removed by the cleaning member to a toner storage container.

The toner container 346 supplies toner to the case of the developing device 343. In the image forming unit 34 that forms a toner image of black (Bk), the toner container 346 supplies toner of black (Bk).

The toner images of the plurality (herein four) of colors formed by the respective image forming units 31 to 34 are superposed on the outer peripheral surface of the intermediate transfer belt 361 when transferred. This forms a color image (toner image) on the outer peripheral surface of the intermediate transfer belt 361.

As shown in FIG. 2, the intermediate transfer device 36 includes the intermediate transfer belt 361, a drive roller 362, a tension roller 363, and a belt cleaning member 364. The intermediate transfer device 36 conveys the toner image formed by the image forming units 31 to 34 to a transfer position P1 (see FIG. 2), where transfer of the toner image by the secondary transfer roller 37 is performed, using the intermediate transfer belt 361.

The intermediate transfer belt 361 is an endless belt to which the color toner images on the photoconductor drums 311, 321, 331, and 341 are transferred. As shown in FIG. 2, the intermediate transfer belt 361 is wrapped around the drive roller 362 and the tension roller 363 that are disposed away from each other in the front-rear direction D2 of the image forming apparatus 10. The drive roller 362 rotates under a driving force supplied by a motor. This causes the intermediate transfer belt 361 to rotate in a rotation direction D4 shown in FIG. 2. As the intermediate transfer belt 361 rotates, the toner image transferred to the outer peripheral surface of the intermediate transfer belt 361 is conveyed to the transfer position P1 where transfer of the toner image by the secondary transfer roller 37 is performed. The belt cleaning member 364 cleans the outer peripheral surface of the intermediate transfer belt 361 after transfer of the toner image is performed at the transfer position P1.

The secondary transfer roller 37 transfers the toner image formed on the outer peripheral surface of the intermediate transfer belt 361 to the sheet supplied by the sheet feed portion 5. As shown in FIG. 2, the secondary transfer roller 37 is placed at a position facing the tension roller 363, with the intermediate transfer belt 361 interposed therebetween, to be in contact with the outer peripheral surface of the intermediate transfer belt 361. The secondary transfer roller 37 is pressed against the tension roller 363 by a biasing member. The secondary transfer roller 37 is electrically connected to the power circuit and, when subjected to a high voltage applied by the power circuit, transfers the toner image formed on the outer peripheral surface of the intermediate transfer belt 361 to the sheet passing through the transfer position P1 where the secondary transfer roller 37 is in contact with the intermediate transfer belt 361.

The fixing device 38 fuses and fixes the toner image transferred to the sheet by the secondary transfer roller 37 onto the sheet. For example, the fixing device 38 includes a fixing roller and a pressure roller. The fixing roller is disposed to be in contact with the pressure roller and heats and fixes the toner image transferred to the sheet onto the sheet. The pressure roller pressurizes the sheet passing through the contact portion between the pressure roller and the fixing roller.

After the image formation, the sheet is discharged to the sheet discharge tray 39.

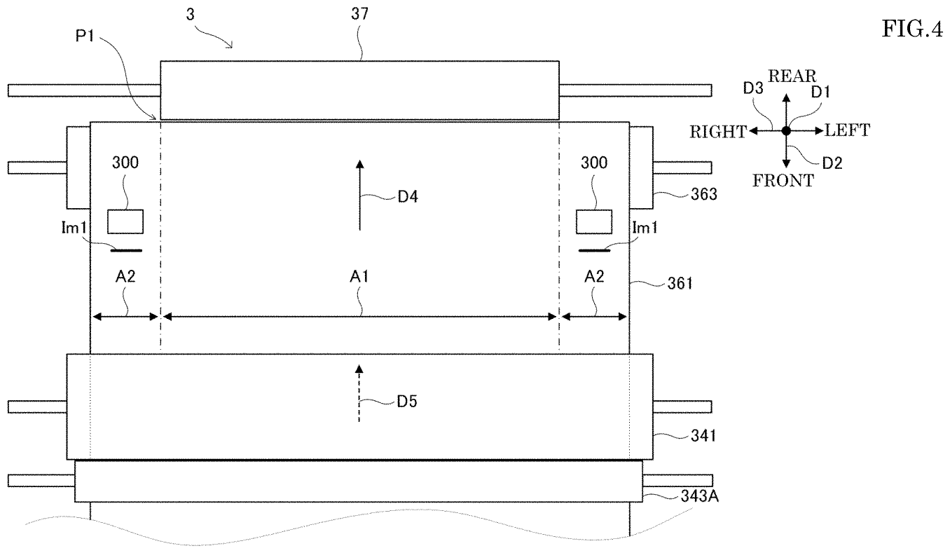

In the present embodiment, the image forming portion 3 further includes registration sensors 300 (see FIG. 2). The registration sensors 300 are optical sensors that detect patch images Im1 (see FIG. 4) formed on a transfer body in the image forming portion 3. “Patch images” in the present disclosure refer to toner images used for detecting distortion or inclination of scan lines of light beams B1 to B4 (see FIG. 3) from the laser scanning unit 4. The patch images are basically not transferred to the sheet. Here, in the present embodiment, toner images are first formed on the surface of the photoconductor drum 341, transferred from the photoconductor drum 341 to the intermediate transfer belt 361, and then transferred from the intermediate transfer belt 361 to the sheet. Accordingly, the photoconductor drum 341 or the intermediate transfer belt 361 is an example of the “transfer body” on which the patch images Im1 are formed. In the present embodiment, we assume that the intermediate transfer belt 361, in particular, is the “transfer body”.

Accordingly, the registration sensors 300 are placed to face the outer peripheral surface of the intermediate transfer belt 361 serving as the transfer body. Specifically, as shown in FIG. 2, the registration sensors 300 are placed downstream of the image forming unit 34 and upstream of the secondary transfer roller 37 in the rotation direction D4 of the intermediate transfer belt 361. This arrangement allows the registration sensors 300 to detect, between the image forming unit 34 and the secondary transfer roller 37, the patch images Im1 formed on the outer peripheral surface of the intermediate transfer belt 361.

Here, as shown in FIG. 4, the axial length of the secondary transfer roller 37 is shorter than the width of the intermediate transfer belt 361. This creates a transfer area A1, which comes into contact with the secondary transfer roller 37, and non-transfer areas A2, which do not come into contact with the secondary transfer roller 37, on the outer peripheral surface of the intermediate transfer belt 361. The non-transfer areas A2 are located on either side of the transfer area A1 on the outer peripheral surface of the intermediate transfer belt 361. Among the images (toner images) formed on the outer peripheral surface of the intermediate transfer belt 361, those formed in the transfer area Al are transferred to the sheet by the secondary transfer roller 37, whereas those formed in the non-transfer areas A2 are not transferred to the sheet. The secondary transfer roller 37 may have an axial length identical to the width of the intermediate transfer belt 361.

The image forming portion 3 includes two registration sensors 300. The two registration sensors 300 are placed at positions aligned in the scanning direction (main scanning direction) of the light beams B1 to B4 to face the outer peripheral surface of the intermediate transfer belt 361. The patch images Im1 are formed in the non-transfer areas A2 on the outer peripheral surface of the intermediate transfer belt 361 and thus are not transferred to the sheet. That is, the two registration sensors 300 are placed at positions that allow the registration sensors 300 to detect the patch images Im1 formed on both sides (non-transfer areas A2) of the transfer area Al on the transfer body (intermediate transfer belt 361) in the scanning direction (main scanning direction) of the light beams B1 to B4. The output from the registration sensors 300 is used by a control portion 44 of the laser scanning unit 4 to determine the amounts of inclination of scan lines of the light beams B1 to B4 (described in detail below). In other words, in the present embodiment, the patch images Im1 are used to determine the amounts of inclination of the scan lines of the light beams B1 to B4. These patch images Im1 formed on either side of the transfer area A1 (non-transfer areas A2) allow the amounts of inclination of the scan lines of the light beams B1 to B4 to be determined while images are being formed in the image forming apparatus 10.

In the present embodiment, the registration sensors 300 are disposed only at both ends in the main scanning direction, and no registration sensor is disposed in the middle part between the ends. This can minimize the number of registration sensors and thus leads to a reduction in the size and cost of the image forming apparatus 10.

### [3] Configuration of Laser Scanning Unit

Next, the configuration of the laser scanning unit 4 will be described in more detail with reference to FIGS. 1, and 3 to 6.

The laser scanning unit 4 forms electrostatic latent images on the photoconductor drums 311, 321, 331, and 341 in the four image forming units 31 to 34, respectively. Accordingly, as shown in FIG. 3, the laser scanning unit 4 outputs the light beams B1, B2, B3, and B4 respectively corresponding to the photoconductor drums 311, 321, 331, and 341. The light beam B1 is emitted to the photoconductor drum 311 according to an input of image data for a yellow (Y) component to form an electrostatic latent image on the photoconductor drum 311 serving as the image-carrying member. The light beam B2 is emitted to the photoconductor drum 321 according to an input of image data for a cyan (C) component to form an electrostatic latent image on the photoconductor drum 321 serving as the image-carrying member. The light beam B3 is emitted to the photoconductor drum 331 according to an input of image data for a magenta (M) component to form an electrostatic latent image on the photoconductor drum 331 serving as the image-carrying member. The light beam B4 is emitted to the photoconductor drum 341 according to an input of image data for a black (Bk) component to form an electrostatic latent image on the photoconductor drum 341 serving as the image-carrying member.

In this manner, the laser scanning unit 4 is configured to be able to output (emit) the plurality (herein four) of light beams B1 to B4 for forming electrostatic latent images to the plurality (herein four) of image forming units 31 to 34 respectively corresponding to the plurality (herein four) of colors. In the present embodiment, the plurality (herein four) of light beams B1 to B4 each traveling along an individual optical path are output from the single laser scanning unit 4. It is noted that the plurality (herein four) of light beams B1 to B4 are not necessarily output from the single laser scanning unit 4. For example, the light beams B1 and B2 may be output from a laser scanning unit 4, and the light beams B3 and B4 may be output from another laser scanning units 4.

In the present embodiment, as shown in FIG. 3, the laser scanning unit 4 includes a light source portion 41 and a scanning portion 42. The scanning portion 42 includes a deflector 43, a plurality of mirrors 421, and a plurality of scanning lenses 422. The light source portion 41 outputs the light beams B1 to B4. The scanning portion 42 scans the light beams B1 to B4 to form electrostatic latent images in the image forming portion 3. FIG. 3 is a schematic view of the configuration of the unit members and does not show the exact shapes and positional relationships of the unit members.

The light source portion 41 emits light beams to the deflector 43. In the present embodiment, the light source portion 41 includes semiconductor lasers serving as light emitting modules to output laser beams. The light source portion 41 includes the plurality (herein four) of light emitting modules and outputs laser beams from the plurality of light emitting modules to form electrostatic latent images respectively corresponding to the colors of yellow (Y), cyan (C), magenta (M), and black (Bk). That is, the light source portion 41 outputs the plurality of light beams B1 to B4.

Specifically, the light emitting modules in the light source portion 41 use semiconductor lasers (LDs: Laser Diodes) as light emitting elements. The LDs lase when electric currents are applied to the semiconductors. In the present embodiment, the light emitting modules have a multibeam structure capable of outputting a plurality of light beams. That is, each of the light emitting modules includes two or more light emitting elements composed of the semiconductor lasers in its package and can cause the plurality of light emitting elements to emit light individually. The light emitting modules with the multibeam structure enable the laser scanning unit 4 to form electrostatic latent images faster and more finely in a compatible manner.

As an example, in the present embodiment, the deflector 43 is a polygon mirror scanner and includes a polygon mirror 431 and a scanner motor 432. That is, the deflector 43 rotates the polygon mirror 431 using the scanner motor 432 and thereby scans light beams from the light source portion 41 in the main scanning direction parallel to the left-right direction D3. It is noted that, instead of the polygon scanner, the deflector 43 may be an acousto-optical element, a hologram scanner, a galvanometer mirror, a micromirror scanner using MEMS (Micro Electro Mechanical Systems) technology, or the like. In addition, the deflector 43 may be integral to the light source portion 41.

The mirrors 421 reflect light beams from the deflector 43. The scanning lenses 422 include fθ lenses. In the present embodiment, the scanning direction along which the scanning portion 42 scans the light beams B1 to B4, in other words, the main scanning direction, is parallel to the left-right direction D3. Accordingly, both the mirrors 421 and the scanning lenses 422 are elongated in the left-right direction D3 serving as the main scanning direction. With this configuration, the laser scanning unit 4 can output light beams from the light source portion 41 toward the image forming units 31 to 34 through the deflector 43, the mirrors 421, and the scanning lenses 422. Here, the laser scanning unit 4 can output the plurality (herein four) of light beams B1 to B4 and scans the light beams B1 to B4 in the main scanning direction to form electrostatic latent images corresponding to the respective colors.

In short, the light beams B1 to B4 deflected by the deflector 43 are reflected off one or more mirrors 421, while passing through one or more scanning lenses 422, and emitted toward the photoconductor drums 311, 321, 331, and 341, respectively, in the image forming portion 3. Accordingly, the mirrors 421 and the scanning lenses 422 are an example of an “optical element” located in the paths of the light beams B1 to B4 output from the light source portion 41.

In this manner, the scanning portion 42 scans the plurality (herein four) of light beams B1 to B4 output from the light source portion 41 to form the plurality (herein four) of electrostatic latent images respectively corresponding to the plurality (herein four) of colors in the image forming portion 3. That is, the plurality of light beams B1 to B4 scanned by the scanning portion 42 correspond one-to-one with the “plurality of colors”. In the present embodiment, the light beam B1 corresponds to yellow (Y), the light beam B2 corresponds to cyan (C), the light beam B3 corresponds to magenta (M), and the light beam B4 corresponds to black (Bk).

The laser scanning unit 4 according to the present embodiment further includes the control portion 44 (see FIG. 5) and a storage portion. The control portion 44 controls unit portions, such as the light source portion 41 and the scanning portion 42, of the laser scanning unit 4. Specifically, the control portion 44 controls the light source portion 41 to output the light beams B1 to B4 from the light source portion 41 individually by any given amounts and at any given timings. That is, the control portion 44 turns on and off each of the plurality of light emitting modules included in the light source portion 41 at any given timings, and controls the amounts of light individually for each of the light emitting modules. The control portion 44 controls the deflector 43 (scanner motor 432) of the scanning portion 42 to scan the light beams B1 to B4 from the light source portion 41 in the scanning portion 42.

The control portion 44 is mainly composed of a computer system including one or more processors and one or more memories. In the laser scanning unit 4, the one or more processors execute programs to implement the function of the control portion 44. The programs may be stored in the memories in advance, provided through telecommunication lines such as the Internet, or stored and provided in a non-transitory computer-readable storage medium such as a memory card or an optical disk. The storage portion includes one or more nonvolatile memories and stores in advance information including control programs to cause the control portion 44 to perform various processes. The control portion 44 may be integral to the integrated control portion 7 of the image forming apparatus 10.

As a related art, there is known an electrophotographic image forming apparatus of a tandem type that includes a plurality of image forming units and that transfers images of different colors in sequence onto a recording material held on a conveyor belt. A laser scanning unit according to the related art can electrically correct inclination of scan lines relative to the main scanning direction and distortion, such as curves, of the scan lines. That is, the related art prevents misregistration of a plurality of images after transfer by detecting the inclination, distortion, and the like and by emitting light beams (light rays) by amounts and at timings that enable correction of the detected inclination, distortion, and the like.

According to the method of the related art, however, an increase in the amounts of correction (i.e., the amounts of inclination, distortion, and the like) causes a reduction in the definition of the formed images, leading to degradation of image quality.

By contrast, in the present embodiment, the laser scanning unit 4 with the configuration below causes little or no degradation of image quality regardless of an increase in the amounts of correction.

That is, as shown in FIG. 5, the laser scanning unit 4 according to the present embodiment includes a first correction portion 81 and a second correction portion 82 in addition to the light source portion 41 and the scanning portion 42. The first correction portion 81 corrects the inclination of the scan lines of the light beams B1 to B4 scanned in the scanning portion 42. The second correction portion 82 corrects the distortion of the scan lines of the light beams B1 to B4 scanned in the scanning portion 42. As an example, in the present embodiment, the second correction portion 82 and an inclination sensing portion 45 (described below) are provided for the control portion 44 as a function of the control portion 44.

“Scan lines” in the present disclosure refer to lines that occur when the light beams B1 to B4 are scanned in the main scanning direction. That is, scan lines occur on the photoconductor drums 311, 321, 331, and 341 in the four image forming units 31 to 34, respectively, as the laser scanning unit 4 scans the light beams B1 to B4 in the main scanning direction (left-right direction D3). Ideally, scan lines are straight lines parallel to the rotational axes of the photoconductor drums 311, 321, 331, and 341, that is, straight lines extending in the main scanning direction (left-right direction D3).

In addition, “inclination of scan lines” in the present disclosure refers to slopes (tilts) of scan lines. Such slopes are also called “skew”. That is, the scan lines may be inclined in the sub-scanning direction (rotation direction D5 of the photoconductor drums 311, 321, 331, and 341) due to, for example, individual variations, deformations, or variations in the installation position of the “optical elements” located in the paths of the light beams B1 to B4, and may be tilted relative to ideal straight lines. The first correction portion 81 corrects such inclination of the scan lines. In addition, “distortion of scan lines” in the present disclosure refers to bends (curves) of scan lines. Such bends are also called “bow”. That is, the scan lines may partially shift from ideal straight lines in the sub-scanning direction (rotation direction D5 of the photoconductor drums 311, 321, 331, and 341) due to, for example, individual variations, deformations, or variations in the installation position of the “optical elements” located in the paths of the light beams B1 to B4. The second correction portion 82 corrects such distortion of the scan lines.

Here, the laser scanning unit 4 outputs the plurality of light beams B1 to B4 for forming electrostatic latent images corresponding to the plurality of colors. It is noted that the inclination and distortion occur in each of the scan lines of the light beams B1 to B4. Accordingly, the first correction portion 81 corrects the inclination of the scan lines of the light beams B1 to B4 individually. Similarly, the second correction portion 82 corrects the distortion of the scan lines of the light beams B1 to B4 individually. In the example below, correction to the scan line of the light beam B4 corresponding to black (Bk) will be described. However, unless otherwise noted, the configuration for correcting the scan line of the light beam B4 described below is also applied to those for correcting the scan lines of other light beams B1 to B3.

The first correction portion 81 applies external mechanical forces to the optical elements located in the path of the light beam B4 to correct the inclination of the scan line of the light beam B4. The first correction portion 81 is configured to be able to apply external mechanical forces to the optical elements located in the path of the light beam (light beam B4) to be corrected among the optical elements (the mirrors 421 and/or the scanning lenses 422).

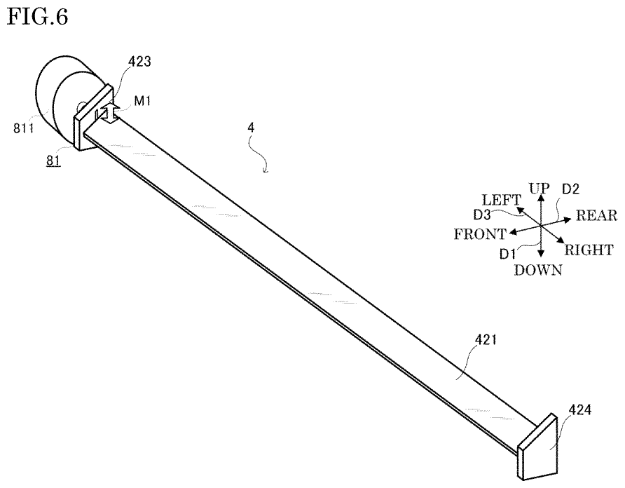

As an example, in the present embodiment, the first correction portion 81 corrects the inclination of the scan line of the light beam B4 by applying an external mechanical force to the mirror 421 located in the path of the light beam B4 as shown in FIG. 6. Specifically, the mirror 421 has long sides extending in the left-right direction D3 serving as the main scanning direction, and the first correction portion 81 applies the external mechanical force to a first end (herein left end) of the long sides of the mirror 421 in the up-down direction D1. Here, the first end of the long sides of the mirror 421 is supported by a movable block 423, whereas a second end (right end) of the long sides of the mirror 421 is supported by a fixed block 424. The first end of the mirror 421 is supported by the movable block 423 to be movable in the up-down direction D1. The second end of the mirror 421 is supported by the fixed block 424 at a fixed position. Accordingly, the first end of the long sides of the mirror 421 supported by the movable block 423 moves in the up-down direction D1 as indicated by an arrow M1 according to the external mechanical force. At this moment, the mirror 421 rotates around the second end of the long sides supported by the fixed block 424. This changes the angle (position) of the mirror 421 relative to the main scanning direction (left-right direction D3), allowing the first correction portion 81 to correct the inclination of the scan line of the light beam B4. The first correction portion 81 is a mechanical correction portion (correction mechanism) that corrects the inclination of the scan line of light beam B4 reflected off the mirror 421 by moving the mirror 421 in the above-described manner; that is, the first correction portion 81 corrects the inclination of the scan line by means of hardware. In the description below, correction performed by the first correction portion 81 by means of hardware is also referred to as “mechanical correction”.

The second correction portion 82 controls the light source portion 41 to correct the distortion of the scan line of the light beam B4. As an example, the second correction portion 82 controls at least the timing to output the light beam B4 or the amount of the light beam B4 to correct the distortion of the scan line of the light beam B4. That is, for example, the second correction portion 82 adjusts the light-on/light-off timing and/or the amount of light for the light emitting module that outputs the light beam B4 in the light source portion 41 to correct the distortion of the scan line of the light beam B4. For example, the second correction portion 82 retards the timing to output the light beam B4 at scanning positions in the main scanning direction. This causes the scan line of the light beam B4 to be partially displaced in the sub-scanning direction at the scanning position, enabling the distortion of the scan line of the light beam B4 to be corrected. The second correction portion 82 is an electrical correction portion that corrects the distortion of the scan line of the light beam B4 by controlling the light source portion 41 in the above-described manner; that is, the second correction portion 82 corrects the distortion of the scan line by means of software. In the description below, correction performed by the second correction portion 82 by means of software is also referred to as “emission control correction”.

Although correction to the scan line of the light beam B4 corresponding to black (Bk) is described as an example here, the scan lines of the other light beams B1 to B3 are also corrected in the same manner. That is, the first correction portion 81 corrects each scan line of the light beams B1 to B4 using the configuration shown in FIG. 6. For example, as to the light beam B1, the first correction portion 81 applies external mechanical forces to the optical elements located in the path of the light beam B1 to correct the inclination of the scan line of the light beam B1. In addition, the second correction portion 82 corrects each scan line of the light beams B1 to B4 in the same manner. For example, as to the light beam B1, the second correction portion 82 controls at least the timing to output the light beam B1 or the amount of the light beam B1 from the light source portion 41 to correct the distortion of the scan line of the light beam B1.

In this manner, the laser scanning unit 4 according to the present embodiment corrects the inclination of the scan lines of the light beams B1 to B4 using the mechanical correction by the first correction portion 81, and corrects the distortion of the scan lines of the light beams B1 to B4 using the emission control correction by the second correction portion 82. Thus, compared with the configuration that corrects both the inclination (skew) and distortion (bow) of the scan lines of the light beams B1 to B4 using the emission control correction as in the above-described related art, the configuration in the present embodiment enables the amounts of correction performed using the emission control correction to be minimized and thus prevents a reduction in the definition of the formed images. As a result, in accordance with the present embodiment, the laser scanning unit 4 causes little or no degradation of image quality regardless of an increase in the amounts of correction.

In addition, compared with the configuration that corrects the distortion of the scan lines of the light beams B1 to B4 using the mechanical correction, mechanisms for the mechanical correction can be simplified in the present embodiment. That is, the distortion of the scan lines can also be corrected by, for example, deforming the optical elements (mirrors 421 and the like) located in the paths of the light beams B1 to B4 such that the optical elements warp using mechanisms for applying external mechanical forces to the middle parts of the long sides of the optical elements. It is noted that such mechanisms for applying external mechanical forces to the middle parts of the long sides of the optical elements are not easily accessible to the user in a case where the mechanisms are of a manually operable type and that such mechanisms have a complex structure in a case where the mechanisms are of an electrically driven type. Furthermore, distortion of scan lines occurring in conjunction with inclination correction to the scan lines (described below) cannot be corrected easily using, in particular, the mechanical correction. On this point, the distortion of the scan lines of the light beams B1 to B4 is corrected using the emission control correction in the present embodiment, simplifying the mechanisms for the mechanical correction without the above-described problems. Thus, the laser scanning unit 4 and the image forming apparatus 10 can easily be reduced in size.

In addition, the image forming apparatus 10 according to the present embodiment can form color images composed of images (toner images) of a plurality of colors superposed on each other. Accordingly, if the scan lines are misaligned between the plurality of light beams B1 to B4 corresponding to the respective colors, registration error occurs and leads to color slippage (misregistration) in the images formed by the image forming apparatus 10. In the present embodiment, however, the first correction portion 81 and the second correction portion 82 respectively correct the inclination and distortion of the scan lines and thereby reduce the misalignment of the scan lines between the light beams B1 to B4. Thus, the misalignment of the scan lines between the plurality of light beams B1 to B4 in the laser scanning unit 4 can be reduced, leading to a reduction in the color slippage (misregistration) in the images formed by the image forming apparatus 10.

The following describes the first correction portion 81 and the second correction portion 82 in more detail.

In the present embodiment, the first correction portion 81 adopts not a manually operable mechanism but an electrically driven mechanism that automatically (electrically) applies external mechanical forces to the optical elements. That is, the first correction portion 81 includes actuators 811 that generate external mechanical forces according to electrical signals. Accordingly, even when the first correction portion 81 is not accessible to the user, the first correction portion 81 can apply external mechanical forces to the optical elements according to the operations on, for example, the operation display portion 6. Thus, the first correction portion 81 can perform the mechanical correction even in the state where the laser scanning unit 4 is incorporated in the image forming apparatus 10, that is, when the light source portion 41 and the scanning portion 42 are ready for use. More specifically, the first correction portion 81 includes the actuators 811 composed of stepping motors. The first correction portion 81 applies electrical signals to the actuators 811 to move the first ends of the long sides of the mirrors 421 in the up-down direction D1 by amounts of travel according to the numbers of pulses included in the electrical signals. Thus, the first correction portion 81 moves the mirrors 421 in a rotational manner by the amounts according to the numbers of pulses to change the angles (positions) of the mirrors 421 relative to the main scanning direction. Instead of the stepping motors, the actuators 811 may be, for example, other types of motors, solenoids, voice coils, or piezoelectric elements.

Here, the inclination and distortion of the scan lines may occur at any time. In particular, the inclination of the scan lines easily occurs under the influence of heat generated by, for example, the fixing device 38 and the like while the image forming apparatus 10 is in use. Accordingly, it is preferable that the inclination of the scan lines be corrected by the first correction portion 81 as needed while the image forming apparatus 10 is in use. Furthermore, when the first correction portion 81 applies external forces to the optical elements to correct the inclination of the scan lines, distortion of the scan lines occurs in conjunction with the application of the external forces. That is, when the first correction portion 81 applies the external mechanical forces to the optical elements, the optical elements deform, although slightly, and the deformation causes distortion of the scan lines. That is, the inclination of the scan lines and the distortion of the scan lines have correlation to each other.

Accordingly, in the present embodiment, the second correction portion 82 corrects the distortion of the scan lines of the light beams B1 to B4 according to the amounts of inclination correction by the first correction portion 81. Thus, although the distortion of the scan lines occurs in conjunction with the inclination correction applied to the scan lines by the first correction portion 81 using the mechanical correction, the distortion can be corrected by the second correction portion 82 using the emission control correction. In particular, since the inclination of the scan lines is corrected by the first correction portion 81 as needed while the image forming apparatus 10 is in use, the ability to correct the distortion of the scan lines occurring every time the inclination correction is performed is very useful.

In addition, the inclination sensing portion 45 determines the amounts of inclination of the scan lines of the light beams B1 to B4 based on the output from the registration sensors 300 that detect the patch images Im1 formed on the transfer body in the image forming portion 3. The control portion 44 drives the first correction portion 81 according to the amounts of inclination detected by the inclination sensing portion 45. Specifically, the control portion 44 determines the amounts of correction performed using the mechanical correction and drives the first correction portion 81 such that the amounts of inclination detected by the inclination sensing portion 45 are canceled out.

That is, the inclination sensing portion 45 uses the patch images Im1, which are formed on the transfer body (intermediate transfer belt 361 in the present embodiment) and detected by the registration sensors 300, to detect the amounts of inclination (amounts of skew) of the scan lines of the light beams B1 to B4. Specifically, as shown in FIG. 4, a pair of patch images Im1 are formed at both ends of the transfer body in the main scanning direction, and the displacement between the patch images Im1 in the sub-scanning direction (rotation direction D4) corresponds to the amount of inclination of a scan line. For example, in a case where the positions of the pair of patch images Im1 match in the sub-scanning direction, the amount of inclination of the scan line is “0”. In other words, a gap in time in which the two registration sensors 300 respectively detect the pair of patch images Im1 corresponds to the amount of inclination of the scan line. In this manner, the amounts of inclination of the scan lines of the light beams B1 to B4 can be determined as needed by the inclination sensing portion 45 based on the output from the registration sensors 300 even while the image forming apparatus 10 is in use.

The laser scanning unit 4 according to the present embodiment further includes a correction storage portion 46. The correction storage portion 46 includes one or more nonvolatile memories and stores correspondences between the amounts of inclination correction by the first correction portion 81 and the amounts of distortion correction by the second correction portion 82. The amounts of inclination correction and the amounts of distortion correction may be stored in the correction storage portion 46 at least in a one-to-one manner. Thus, the correspondence information stored in the correction storage portion 46 may be, for example, in a table format or may be a function (coefficients and the like) for deriving the amounts of distortion correction from the amounts of inclination correction. The second correction portion 82 can derive the amounts of distortion correction from the amounts of inclination correction by the first correction portion 81 by referring to the correction storage portion 46. That is, the second correction portion 82 corrects the distortion of the scan lines of the light beams B1 to B4 by the amounts of distortion correction associated one-to-one with the amounts of inclination correction. Thus, when the amounts of inclination correction by the first correction portion 81 are determined, the amounts of distortion correction by the second correction portion 82 can be uniquely determined from the amounts of inclination correction. This simplifies calculation process for determining the amounts of distortion correction. The correspondences between the amounts of inclination correction and the amounts of distortion correction are not necessarily stored in the laser scanning unit 4. The correspondences may be stored in, for example, the storage portion of the image forming apparatus 10 or an external apparatus (server apparatus or the like) that can communicate with the image forming apparatus 10.

### [4] Laser Scanning Method

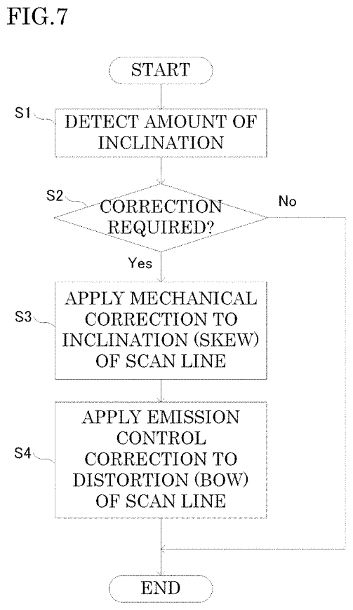

Next, a laser scanning method, which is an operation of the laser scanning unit 4 according to the present embodiment, will be described with reference to FIGS. 7 to 10. Here, steps S1, S2, . . . in FIG. 7 represent the numbers of processing procedures (steps) performed by the laser scanning unit 4. The laser scanning method is performed as needed while, for example, the image forming apparatus 10 is in use. In addition, although the scan line of the laser beam corresponding to black (Bk) is corrected by the laser scanning method described below, the laser scanning unit 4 performs similar processes also in a case where the scan line of the light beam corresponding to yellow (Y), cyan (C), or magenta (M) is corrected.

### <Step S1>

First, in step S1, the laser scanning unit 4 determines the amount of inclination of the scan line of the light beam B4 using the inclination sensing portion 45 (control portion 44). At this moment, the inclination sensing portion 45 periodically determines the amount of inclination based on the output from the registration sensors 300. In the present embodiment, the patch images Im1 formed on either side of the transfer area Al allow the amount of inclination of the scan line to be determined while images are being formed.

### <Step S2>

In step S2, it is determined whether or not inclination correction to the scan line is required. That is, in a case where inclination correction to the scan line is required (Yes in step S2), the laser scanning unit 4 moves the process to step S3. In a case where inclination correction to the scan line is not required (No in step S2), the laser scanning unit 4 bypasses steps S3 and S4 and ends the series of processes. Here, the control portion 44, for example, determines the necessity of the correction based on the amount of inclination determined in step S1. In a case where the amount of inclination exceeds a predetermined threshold, the control portion 44 determines that the inclination of the scan line needs to be corrected.

### <Step S3>

In step S3, the first correction portion 81 corrects the inclination (skew) of the scan line of the light beam B4 using the mechanical correction. In the present embodiment, the first correction portion 81 is electrically driven. Thus, the control portion 44 drives the actuator 811 to perform the mechanical correction. At this moment, the amount of correction by the first correction portion 81, that is, the amount of travel of the optical element is determined such that the amount of inclination determined in step S1 is canceled out. The first correction portion 81 applies an electrical signal to the actuator 811 and adjusts the amount of correction (amount of travel of the optical element) by the number of pulses in the electrical signal.

### <Step S4>

In step S4, the second correction portion 82 corrects the distortion (bow) of the scan line of light beam B4 using the emission control correction. That is, the second correction portion 82 controls the timing to output the light beam B4 and/or the amount of the light beam B4 to correct the distortion of the scan line of the light beam B4. At this moment, the amount of distortion correction by the second correction portion 82 is derived from the amount of inclination correction by the first correction portion 81 based on the correspondence between the amount of inclination correction and the amount of distortion correction in the correction storage portion 46.

The procedure of the laser scanning method described above is only an example, and the order of the processes shown in the flowchart in FIG. 7 may be changed as appropriate, or another process may be added.

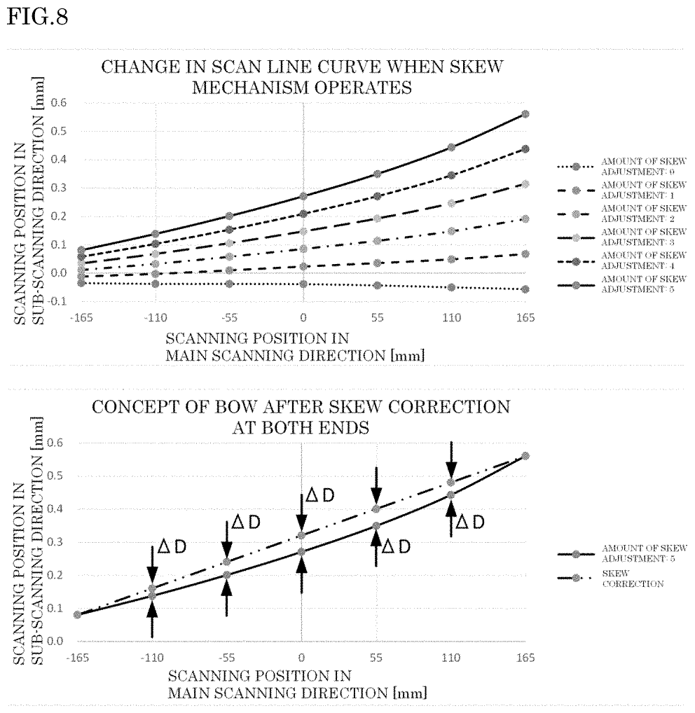

Next, the significance of the laser scanning unit 4 according to the present embodiment will be described with reference to FIGS. 8 to 10. In FIG. 8, a graph at the top shows the scan lines subjected to the mechanical correction by the first correction portion 81, and a graph at the bottom shows one of the scan lines. In each graph, the horizontal axis represents the scanning position in the main scanning direction (image height), and the vertical axis represents the scanning position in the sub-scanning direction. In addition, in FIGS. 8 to 10, the amounts of inclination correction performed by the first correction portion 81 using the mechanical correction are defined as “amounts of skew adjustment”, and the values thereof correspond to the number of pulses applied to the actuator 811 composed of a stepping motor. Here, it is assumed that the scan lines do not have any inclination (skew) components.

That is, as shown at the top of FIG. 8, the curvatures of the scan lines vary depending on the amounts of inclination correction by the first correction portion 81. This is caused by the distortion of the scan lines occurring in conjunction with the inclination correction to the scan lines. The distortion (bow) components of the scan lines can be extracted by removing the inclination (skew) components of the scan lines from the above-described scan lines. That is, for example, in a case of “amount of skew adjustment: 5” shown in the graph at the top of FIG. 8, which requires the maximum amount of distortion correction, the distortion of the scan line is extracted as shown at the bottom of FIG. 8. The inclination of the scan line is represented by a difference between the scanning positions in the sub-scanning direction at both ends of the scan line, that is, at the image heights of “−165 mm” and “165 mm”. In the example shown at the bottom of FIG. 8, the inclination of the scan line is “0.479 mm”. The distortion of the scan line at this moment is represented by a difference ΔD between the scan line and a straight line connecting both ends of the scan line (skew correction). That is, the distortion of the scan line varies depending on the image height, whereas the inclination of the scan line has one value for the one scan line. In the example shown at the bottom of FIG. 8, the distortion of the scan line is “0.051 mm” maximum at the image height of “55 mm”. In this manner, the distortion of the scan line (0.051 mm) is smaller than the inclination of the scan line (0.479 mm).

In short, the inclination of the scan line increases depending on the relative positional relationship between the photoconductor and the laser scanning unit 4, requiring the amount of inclination correction to the scan line to be relatively large. On the other hand, because the distortion of the scan line is mainly caused by the deformation of the optical element, the distortion is sufficiently small compared with the inclination of the scan line, and the amount of distortion correction to the scan line is also small. In this manner, in the present embodiment, the inclination of the scan line, which requires a large amount of correction, is corrected using the mechanical correction, and the distortion of the scan line, which requires a small amount of correction, is corrected using the emission control correction. This method can reduce the degradation of image quality. That is, minimizing the amount of correction performed using the emission control correction leads to little or no degradation of image quality regardless of an increase in the amount of overall correction.

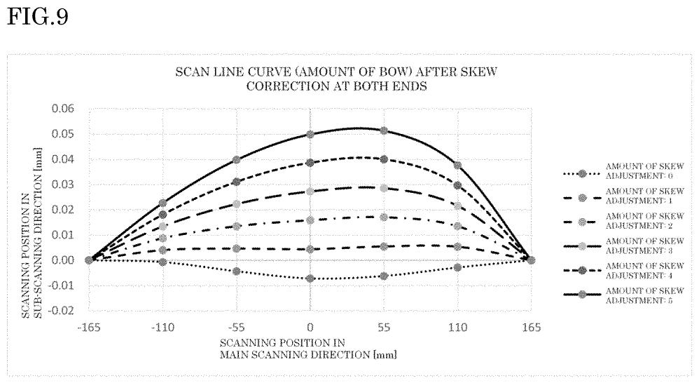

FIG. 9 is a graph showing example correspondences between the amounts of inclination correction by the first correction portion 81 and the amounts of distortion correction by the second correction portion 82. That is, the graph shown in FIG. 9 can be obtained by removing the inclination (skew) components from the scan lines, respectively corresponding to the amounts of inclination correction by the first correction portion 81, shown in the example at the top of FIG. 8. As is clear from FIG. 9, the amounts of distortion of the scan lines vary depending on the amounts of inclination correction by the first correction portion 81. Accordingly, in the present embodiment, the relationships between the amounts of inclination correction and the amounts of distortion are stored in the correction storage portion 46 as the correspondences between the amounts of inclination correction and the amounts of distortion correction.

Storing the amounts of distortion of the scan lines having different values for the respective image heights in the correction storage portion 46 in advance negates the need for sensors for detecting the amounts of distortion of the scan lines. Omission of such sensors is advantageous because a large number of sensors are required to detect the amounts of distortion of the scan lines at a large number of image heights. It is noted that the correspondences between the amounts of inclination correction by the first correction portion 81 and the amounts of distortion correction by the second correction portion 82 vary in each laser scanning unit 4. Thus, it is preferable that the correspondences between the amounts of distortion correction and the amounts of inclination correction be stored by driving the first correction portion 81 and measuring the amounts of distortion correction corresponding to the amounts of inclination correction during, for example, the production (including testing) of the laser scanning unit 4. It is preferable that the correction storage portion 46 storing the correspondences be included in the laser scanning unit 4 or accompany the laser scanning unit 4.

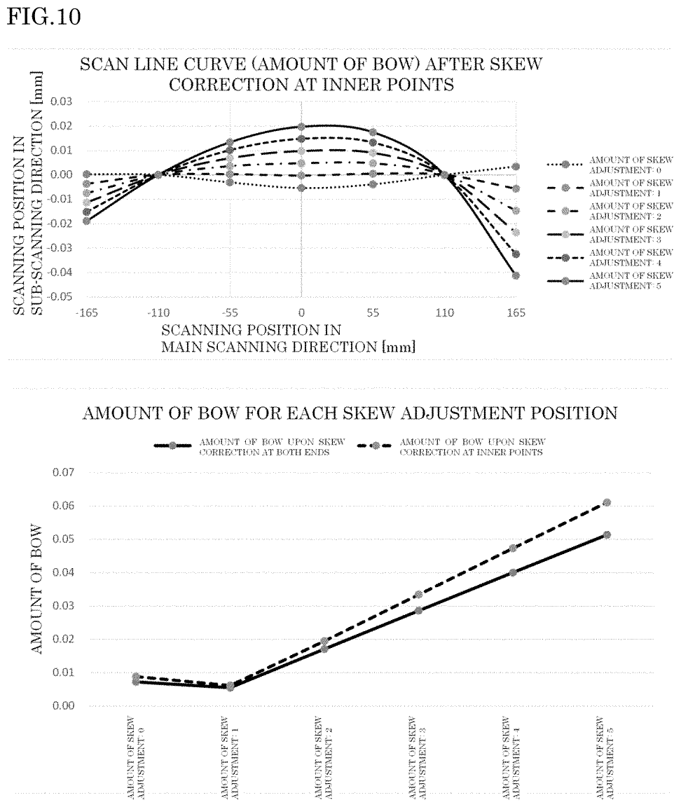

FIG. 10 includes graphs for showing the significance of defining the inclination of each scan line using both ends of the scan line in the main scanning direction. In FIG. 10, the graph at the top is of a type similar to FIG. 9 and shows a case where the inclination of the scan lines is defined using inner points on the scan lines in the main scanning direction; whereas the graph at the bottom shows the amounts of distortion of the scan lines for each amount of inclination correction. In the graph at the bottom of FIG. 10, the horizon axis represents the amount of inclination correction, and the vertical axis represents the amount of distortion of the scan line. It is noted that, in the graph at the bottom of FIG. 10, the amounts of distortion of the scan lines are represented by values obtained by subtracting the minimum values from the maximum values. That is, the inclination of the scan lines can also be defined using two inner points in the main scanning direction, for example, at the image heights of “−110 mm” and “110 mm” instead of both ends. The graph at the top of FIG. 10 shows the correspondences between the amounts of inclination correction by the first correction portion 81 and the amounts of distortion correction by the second correction portion 82 obtained when the first correction portion 81 performs correction such that the inclination of the scan lines is canceled out in the above-described case.

However, as shown at the bottom of FIG. 10, the amounts of distortion of the scan lines obtained in the case where the inclination of the scan lines is defined using the two inner points in the main scanning direction are larger than those obtained in the case where the inclination of the scan lines is defined using both ends in the main scanning direction for each amount of inclination correction. This is because the optical element tends to be deformed into a cubic curve having the support located in the middle due to the mechanism of the first correction portion 81, and thus the scan lines from which the amounts of inclination correction are subtracted become convex or concave. Thus, defining the inclination of the scan lines using both ends in the main scanning direction and canceling the inclination of the scan lines out as in the present embodiment can minimize the amounts of distortion and thereby minimize the amounts of distortion correction performed using the emission control correction. In the case where the inclination of the scan lines is defined using both ends in the main scanning direction, the registration sensors 300 can be advantageously placed at both ends in the main scanning direction.

### [5] Modification

The plurality of components included in the image forming apparatus 10 may be dispersedly provided for a plurality of housings. For example, the image reading portion 2 and the image forming portion 3 may be provided for different housings.

In addition, instead of the electrically driven type, the first correction portion 81 may adopt, for example, a manually operable mechanism that allows a user to adjust the positions of the optical elements manually. As an example, the first correction portion 81 includes screw-in adjustment portions that are rotated to adjust the positions of the optical elements. Furthermore, in addition to or instead of the function of moving the optical elements in a rotational manner, the first correction portion 81 may have the function of moving the optical elements in a parallel manner by applying external mechanical forces to the optical elements.

In addition, the configuration of the laser scanning unit 4 according to Embodiment 1 is not limited to the image forming apparatus 10 of the tandem type including a plurality of photoconductors (photoconductor drums) corresponding one-to-one with a plurality of colors, and may be applicable to a monochrome image forming apparatus. Also in this case, the inclination and distortion of the scan lines can be corrected using the laser scanning unit 4.

### Embodiment 2

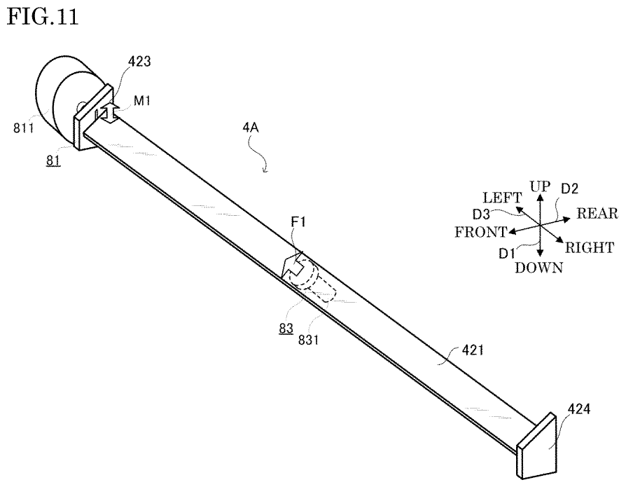

As shown in FIG. 11, the image forming apparatus 10 according to the present embodiment differs from the image forming apparatus 10 according to Embodiment 1 in that a laser scanning unit 4A includes a third correction portion 83. In the description below, common reference numbers and symbols are used for components identical to those in Embodiment 1, and the detailed descriptions will be omitted.

The third correction portion 83 applies external mechanical forces to the optical elements located in the paths of the light beams B1 to B4 to correct the distortion of the scan lines of the light beams B1 to B4. As an example, in the present embodiment, the third correction portion 83 corrects the distortion of the scan lines of the light beams B1 to B4 by applying external mechanical forces F1 to the mirrors 421 located in the paths of the light beams B1 to B4 as shown in FIG. 11. Specifically, the mirrors 421 have long sides extending in the left-right direction D3 serving as the main scanning direction, and the third correction portion 83 applies the external mechanical force F1 to the middle part of the long sides of each mirror 421 from the bottom side (obliquely from lower back) to the top side (obliquely forward and upward). As a result, the mirror 421 deforms, or warps, such that the middle part of the long sides protrudes obliquely forward and upward according to the magnitude of the external mechanical force F1.

With this configuration, the distortion of the scan lines of the light beams B1 to B4 is corrected by the third correction portion 83 using the mechanical correction in addition to the emission control correction by the second correction portion 82. This further reduces the amounts of distortion correction applied to the scan lines using the emission control correction, resulting in little or no degradation of image quality.

In the present embodiment, the third correction portion 83 adopts a manually operable mechanism that allows a user to adjust the magnitude of the external mechanical forces F1 manually. That is, the third correction portion 83 includes screw-in adjustment portions 831 that receive operations for adjusting the external mechanical forces F1. Rotating the adjustment portions 831 causes the feed of the adjustment portions 831 to be adjusted, and thereby the magnitude of the external mechanical forces F1 is adjusted. It is noted that, instead of the manually operable type, the third correction portion 83 may be of an electrically driven type that generates the external mechanical forces F1 using, for example, actuators that generate power based on electrical signals.

### Embodiment 3

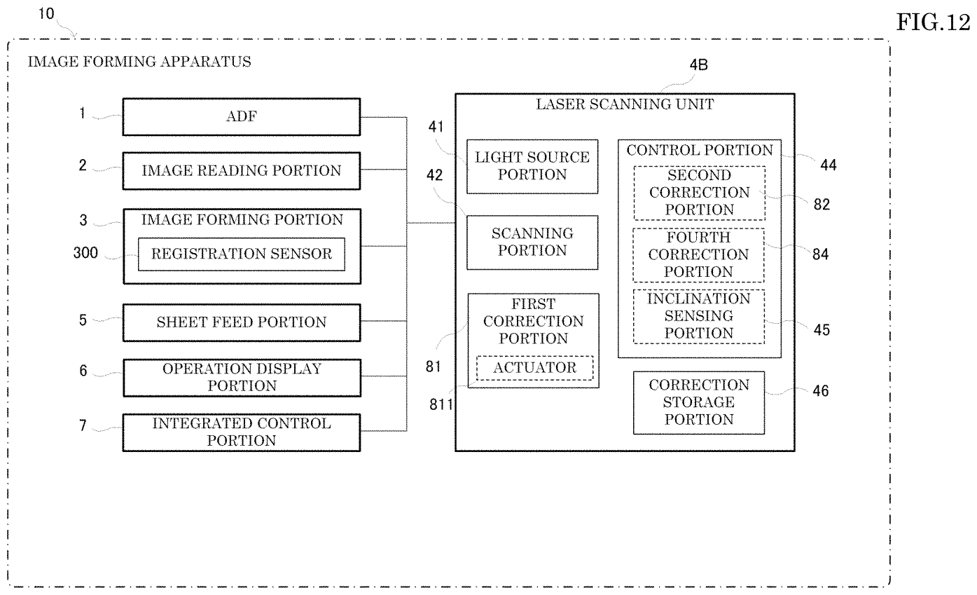

As shown in FIG. 12, the image forming apparatus 10 according to the present embodiment differs from the image forming apparatus 10 according to Embodiment 1 in that a laser scanning unit 4B includes a fourth correction portion 84. In the description below, common reference numbers and symbols are used for components identical to those in Embodiment 1, and the detailed descriptions will be omitted.

The fourth correction portion 84 controls the light source portion 41 to correct the inclination of the scan lines of the light beams B1 to B4. As an example, in the present embodiment, the fourth correction portion 84 is provided for the control portion 44 as a function of the control portion 44. The fourth correction portion 84 corrects the inclination of the scan lines of the light beams B1 to B4 using the emission control correction as does the second correction portion 82. That is, the fourth correction portion 84 controls at least the timings to output the light beams B1 to B4 or the amounts of the light beams B1 to B4 to correct the inclination of the scan lines of the light beams B1 to B4. With this configuration, the inclination of the scan lines of the light beams B1 to B4 is corrected by the fourth correction portion 84 using the emission control correction in addition to the mechanical correction by the first correction portion 81. This reduces the amounts of inclination correction applied to the scan lines using the mechanical correction. The configuration according to Embodiment 3 may be combined with the configuration according to Embodiment 2.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A laser scanning unit comprising:
a light source portion outputting a light beam;
a scanning portion configured to scan the light beam to form an electrostatic latent image in an image forming portion;
a first correction portion configured to apply an external mechanical force to an optical element located in a path of the light beam to correct inclination of a scan line of the light beam; and
a second correction portion configured to control the light source portion to correct distortion of the scan line of the light beam.

2. The laser scanning unit according to claim 1, wherein
the first correction portion includes an actuator that generates the external mechanical force according to an electrical signal.

3. The laser scanning unit according to claim 1, further comprising:
an inclination sensing portion configured to determine an amount of inclination of the scan line of the light beam based on output from registration sensors that detect patch images formed on a transfer body in the image forming portion.

4. The laser scanning unit according to claim 3, wherein
the registration sensors are placed at positions that allow the registration sensors to detect the patch images, the patch images being formed on both sides of a transfer area on the transfer body in a scanning direction of the light beam.

5. The laser scanning unit according to claim 1, wherein
the second correction portion corrects the distortion of the scan line of the light beam according to an amount of inclination correction by the first correction portion.

6. The laser scanning unit according to claim 5, wherein
the second correction portion corrects the distortion of the scan line of the light beam by an amount of distortion correction associated one-to-one with the amount of inclination correction.

7. The laser scanning unit according to claim 1, further comprising:
a third correction portion configured to apply an external mechanical force to the optical element located in the path of the light beam to correct the distortion of the scan line of the light beam.

8. The laser scanning unit according to claim 1, further comprising:
a fourth correction portion configured to control the light source portion to correct the inclination of the scan line of the light beam.

9. An image forming apparatus comprising:
the laser scanning unit according to claim 1; and
an image-carrying member on which the electrostatic latent image is formed by the light beam output from the laser scanning unit.

10. A laser scanning method comprising:
outputting a light beam from a light source portion;
scanning the light beam to form an electrostatic latent image in an image forming portion;
applying an external mechanical force to an optical element located in a path of the light beam to correct inclination of a scan line of the light beam; and
controlling the light source portion to correct distortion of the scan line of the light beam.

11. A non-transitory computer-readable storage medium storing a program therein, wherein when executed by at least one processor, the program causes the processor to:
output a light beam from a light source portion;
scan the light beam to form an electrostatic latent image in an image forming portion;
apply an external mechanical force to an optical element located in a path of the light beam to correct inclination of a scan line of the light beam; and
control the light source portion to correct distortion of the scan line of the light beam.
